(19) United States
(12) Patent Application Publication
(10) Pub. No.: US 2004/0007089 A1
(43) Pub. Date: Jan. 15, 2004

(54) Bicycle crankarm

(76) Inventor: Jeeng-Neng Fan, Taoyuan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/191,526

(22) Filed: Jul. 10, 2002

(51) Int. Cl. G05G 1/14

(52) U.S. Cl. 74/594.1

(57) ABSTRACT

An improved bicycle crankarm consisting of a crankarm having a fixed member and a swivel member. The swivel member provides for the mounting of a pedal. After mounting, the pedal is in a perpendicular state relative to the crankarm and provides for treadling. When the host bicycle is not being utilized or prepared for packaging, the pedal can be directly pivoted into an overlaid configuration relative to the upper and lower ends of the crankarm. As such, the host bicycle does not have the inadequate strength drawbacks that are often the case with a foldable pedal. At the same time, the present invention provides for operating convenience and effectively achieves the objectives of reduced physical dimensions and space.

### BACKGROUND OF THE INVENTION

1) Field of the Invention

The invention herein relates to bicycle componentry, specifically an improved bicycle crankarm.

2) Description of the Prior Art

A conventional crankarm structure onto which a pedal is mounted for utilization as a bicycle component, as indicated in FIG. 1, typically consists of a one-piece crankarm 10 having its inner end attached to a chainring 20, with a pedal 30 installed onto its outer end, wherein the said pedal 30 has a foot contact section 301 capable of spinning freely on an axle 302 that is positioned through the center and up to the two ends of the foot contact section 301 and perpendicularly fastened to the crankarm 10; as such, the said pedal 30 fastened to the crankarm 10 by means of the axle 302 not only provides for treadling by the bicycle rider, but the design in which the said axle 302 penetrates to the two ends of the foot contact section 301 also provides for the sturdy support of force treadled by the bicycle rider onto the foot contact section 301 to thereby ensure safe bicycle riding. While it cannot be denied that such an operational method is workable and of value and, furthermore, is the most common method utilized by conventional bicycles, after the said two pedals 30 are each perpendicularly fastened by means of their respective axles 302 to the left and right crankarms 10, since they are protuberant at the two sides of the bicycle, when the such a bicycle is in a state of non-use or assembled and following completion prepared for packaging (packed in the paper cartons) and shipping, the said two protuberant pedals 30 have the obvious shortcomings of larger space occupancy and increased packaging carton dimensions. As such, to reduce packaging carton size, lessen container costs, and raise container load volume, most bicycle manufacturers do not assemble pedals to bicycles as they exit the factory. Pedals are installed by retailers and users after shipment to destinations, which is troublesome and inconvenient.

To address the said situation, some manufacturers have introduced, as indicated in FIG. 2 and FIG. 3, a foldable pedal 30 in which the foot contact section 301 can be folded down such that they effectively occupy less space than the said conventional and which consists of an axle 302 of shorter proportions, a tubular mount 303 capable of spinning freely on it, with the said foot contact section 301 being U-shaped (as shown by the crosshatched lines in FIG. 3) and hinged to the tubular mount 303 by locating pins 304 such that it pivots freely; additionally, a catch body 305 is disposed at the inner edge of the U-shaped foot contact section 301 and an elastic body 306 controls the engagement of the tubular mount 303 as the foot contact section 301 is unfolded and folded at the tubular mount 303. Referring to FIG. 4, FIG. 5, and FIG. 6, when the host bicycle is in a state of non-use, the catch body 305 is pressed inward (as shown by the direction indicated by the arrowhead) to disengage its front extremity 3051 from the tubular mount 303 and since said foot contact section 301 is no longer retained, this enables it to be folded upward and downward at the axis points of the locating pins 304 such that it is parallel to the lateral surface of the crankarm 10 and not in a perpendicular state (as shown in FIG. 6) and, as such, this effectively improves the larger space occupancy and physical dimensions drawbacks of the said conventional pedal 30 which is always perpendicular to the crankarm 10. Of course, when the bicycle is to be ridden, it is only necessary to press the catch body 305 inward and pull the foot contact section 301 upward, causing the front extremity 3051 of the catch body 305 to engage the tubular mount 303 (see FIG. 2 and FIG. 3) such that the said foot contact section 301 is unfolded and perpendicular to the crankarm 10 to provide for treadling.

It should be mentioned that when a bicycle featuring the arrangement approach of the said foldable pedal 30 and crankarm 10 is not being utilized, the folding of the said foot contact section 301 allows for more space saving than the conventional non-foldable pedal, is workable and of value and, furthermore, is the most common method utilized by current conventional bicycles. However, in actual implementation, manufacturers have discovered that there are still a few imperfections which require further improvement, including:

1. Since the support and force application positions when the said foot contact section 301 is unfolded are at adjoining areas between the front end 3051 of the catch body 305 and the tubular mount 303—unlike that of the conventional which are at the two ends of the foot contact section 301 supported by the axle 302, therefore, the foot contact area 301 must be somewhat weaker with regard to treading force sustaining capability and given that the treadling force is greater at the outer side of the foot contact area 301, the catch body 305 front end 3051 is subjected to a larger magnitude of force and, furthermore, there is a higher probability that situations symptomatic of insufficient strength will occur.

2. Since the support points when the said foot contact section 301 is unfolded are at the adjoining areas between the tubular mount 303 and the front end 3051 of the catch body 305, the adjoining areas cannot be immoderately small and hazardously lacking in support strength and, as such, the tubular mount 303 is normally not too short (normally a fraction less than half the length of the foot contact section 301 and even half the length of the foot contact section 301) and, as such, when the foot contact section 301 is folded and placed in a parallel state at the side of the crankarm 10, as indicated in FIG. 6, the length L of both the axle 302 fastened section 3021 and the tubular mount 303 remain perpendicularly projecting from the side of the crankarm 10; given that the said left and right foot contact section 301 have a total projecting length of 2L, this detracts from having bicycle so equipped meet the expected objectives of conserving space and reducing physical dimensions. If fact, when manufacturers of such folding pedal models package such bicycles, it is the same as not assembling pedals to bicycles to prevent increased physical dimensions.

Based on the preceding description, the said conventional bicycle pedal and crankarm implementation method has aspects that are obviously still in need of improvement and breakthroughs.

### SUMMARY OF THE INVENTION

The primary objective of the invention herein is to provide an improved bicycle crankarm, wherein after the said pedal is mounted to a crankarm swivel member, the said swivel member is easily pivoted such that the pedal is brought into a perpendicular or an overlaid state relative to the upper and lower extent of the crankarm, the said pedal is capable of not only providing for treadling and uncompromised bicycle riding operation, but when a bicycle so equipped is not being utilized or packaged, it is not prominent at the outer side of the crankarm and thereby effectively conserves space and reduces physical dimensions.

Another objective of the invention herein is to provide an improved bicycle crankarm, wherein the said swivel member can be pivoted to posture the pedal on it into overlaid state relative to the upper and lower extent of the crankarm to effectively conserve space and reduce physical dimensions and, furthermore, the pedal does not have to be a folding type, but can be a conventional non-folding variety, thereby ensuring its strength and durability during actual utilization.

Yet another objective of the invention herein is to provide an improved bicycle crankarm in which since the fixed member and the swivel member are conjoined along a common linear axis and the pedal is not perpendicularly situated, when the pedal is treadled during bicycle riding, it is subjected to less force to ensure safe utilization.

### BRIEF DESCRIPTION OF THE DRAWINGS

FIG. 1 is an isometric drawing that illustrates the operation of a conventional crankarm equipped with a non-foldable pedal.

FIG. 2 is an orthographic drawing that illustrates the operation of a conventional crankarm equipped with a foldable pedal (shown in cross-sectional view), as viewed from a anterior perspective with the catch body engaged.

FIG. 3 is a drawing of FIG. 2 as viewed from a top perspective.

FIG. 4 is an orthographic drawing that illustrates the operation of a conventional crankarm equipped with a foldable pedal (shown in cross-sectional view), as viewed from a anterior perspective with the catch body disengaged.

FIG. 5 is a drawing of FIG. 4, as viewed from a top perspective.

FIG. 6 is an orthographic drawing that illustrates the operation of the conventional folding pedal, as viewed from an anterior perspective.

FIG. 7 is an isometric drawing of an embodiment of the invention herein (1).

FIG. 8 is an exploded drawing of FIG. 7.

FIG. 9 is an orthographic drawing of FIG. 7, as viewed from an anterior perspective.

FIG. 10 is an orthographic drawing of FIG. 9, as viewed from a top perspective.

FIG. 11 is an orthographic drawing of FIG. 9 that shows the adjustment nut transposed outward.

FIG. 12 is an orthographic drawing of FIG. 11 that shows the pulling inward of pedal and swivel member.

FIG. 13 is an orthographic drawing of FIG. 12 that shows the swivel member and the pedal pivoted 90 degrees.

FIG. 14 is an orthographic drawing of FIG. 13, as viewed from a top perspective.

FIG. 15 is an isometric drawing of another embodiment of the invention herein.

### DETAILED DESCRIPTION OF THE INVENTION

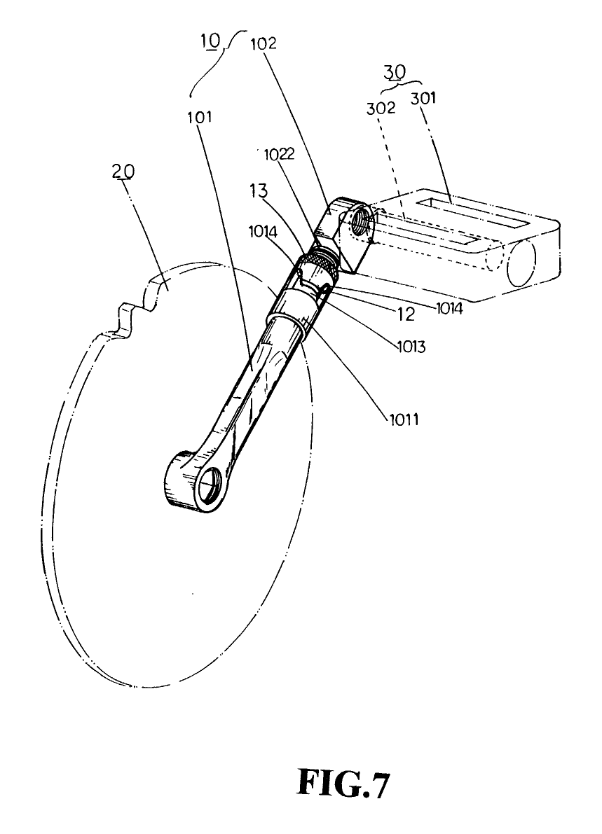

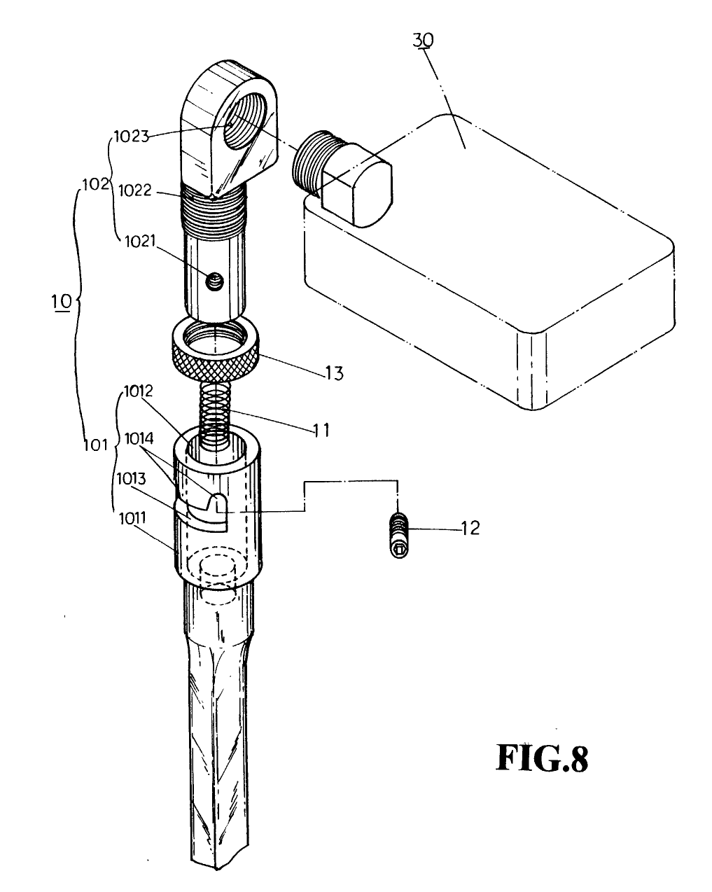

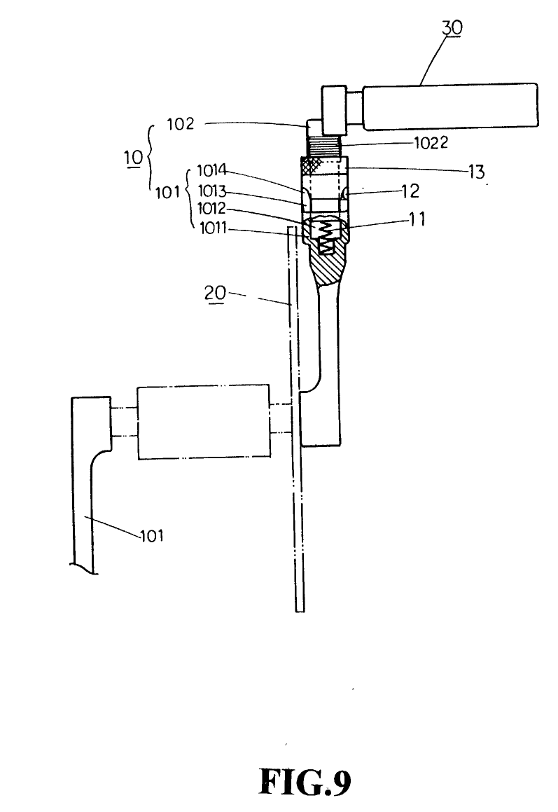

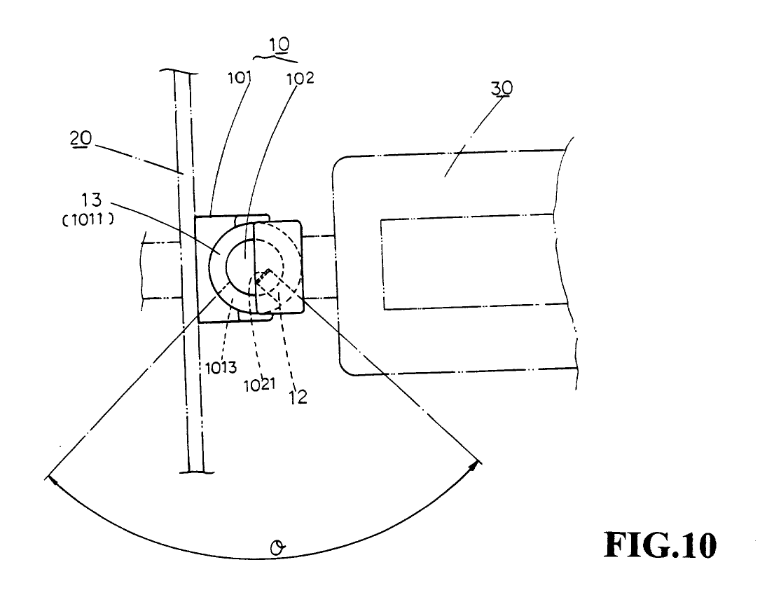

Referring to FIG. 7, FIG. 8, FIG. 9, and FIG. 10, the invention herein is an improved bicycle crankarm, wherein the improved crankarm 10 is comprised of a fixed member 101 and a swivel member 102. As shown in the embodiment, the said fixed member 101 is attached to a chainring 20 at its inner end and a barrel 1011 having a recess 1012 is disposed in its outer end, a transverse guide slot 1013 having an included angle θ of approximately 90 degrees between its two ends is continuously formed in the wall of the barrel 1011, a detent notch 1014 extends outward from each of the two ends of the said guide slot 1013, and an elastic component 11 is seated in the said recess 1012; the said swivel member 102 is such that its inner end pivots freely in the outer end of the fixed member 101 with the elastic component 11 seated inside the recess 1012, a first threaded hole 1021 is tapped at a certain height for fastening a locating screw 12 (which can be a set screw) which is installed at the detent notch 1014 position at the two ends of the transverse guide slot 1013 of the fixed member 101, external threads 1022 are died near the outer end that accommodates the placement of an adjustment nut 13, and a second threaded hole 1023 is tapped in the extreme outer end to provide for mounting a pedal 30.

In the said arrangement, since the fixed member 101 transverse guide slot 1013 has an included angle θ of approximately 90 degrees between its two ends and the said swivel member 102 consists of a locating screw 12 that is fastened in the guide slot 1013 area, therefore, to enable the installation of the pedal 30 for efficient treadling operation on the swivel member 102, the position (orientation) of the said guide slot 1013 is such that when the locating screw 12 is moved to a detent notch 1014 at one of its ends, the pedal 30 is in a perpendicular state relative to the crankarm 10 or the chainring 20.

In the said structural embodiment of the invention herein, after the inner end of the said swivel member 102 is placed into the recess 1012 of the fixed member 101 in a freely pivotable state, the decompressive spring force of the seated elastic component 11 is constantly exerted against it and the locating screw 12 fastened into the first threaded hole 1021 in its wall is situated in the transverse guide slot 1013 of the fixed member 101, therefore, the locating screw 12 blocks movement and the said swivel member 102 is conjoined and positioned in the fixed member 101 under tension without loosening. Furthermore, since there is a detent notch 1014 at each of the two ends of the said transverse guide slot 1013 which, furthermore, has an included angle θ of approximately 90 degrees, after the said swivel member 102 is conjoined under tension to the fixed member 101, in addition to its free pivoting capability, the pivotal travel of the swivel member 102 is limited by the locating screw 12 to remain inside the range of the said included angle because its spring-loaded engagement in the detent notch 1014 at the two ends only enables the swivel member 102 to pivot within the included angle θ between the two ends of the said guide slot 1013.

Of course, since the said swivel member 102 has the second threaded hole 1023 tapped in its outer end to provide for the installation of a pedal 30, when it is pivoted and the coordination of the fixed member 101 guide slot 1013 and the locating screw 12 shifts the locating screw 12 to a detent notch 1014 at one end of the guide slot 1013 such that the pedal 30 is in a perpendicular state relative to the crankarm 10 or the chainring 20, the pedal 30 installed to the swivel member 102 provides for the fully reliable treadling operation by the bicycle rider.

Given the said arrangement, since the said swivel member 102 has the adjustment nut 13 fastened along the external threads 1022 near the outer end, with both it and the locating screw 12 engaging a detent notch 1014 at one end of the guide slot 1013 subject to the effect of the elastic component 11 that is in a decompressive state inside the recess 1012 of the fixed member 101, it does not loosen following conjoinment to the fixed member 101; as the said adjustment nut 13 is capable of being transposed inward such that its bottom portion makes direct contact against the end section of the fixed member 101 (as shown in FIG. 7 and FIG. 9), the said swivel member 102 is consequently kept in a completely and, furthermore, positively immovable state such that the pedal 30 installed on it remains securely positioned without the occurrence of treadling inefficiencies and hazards.

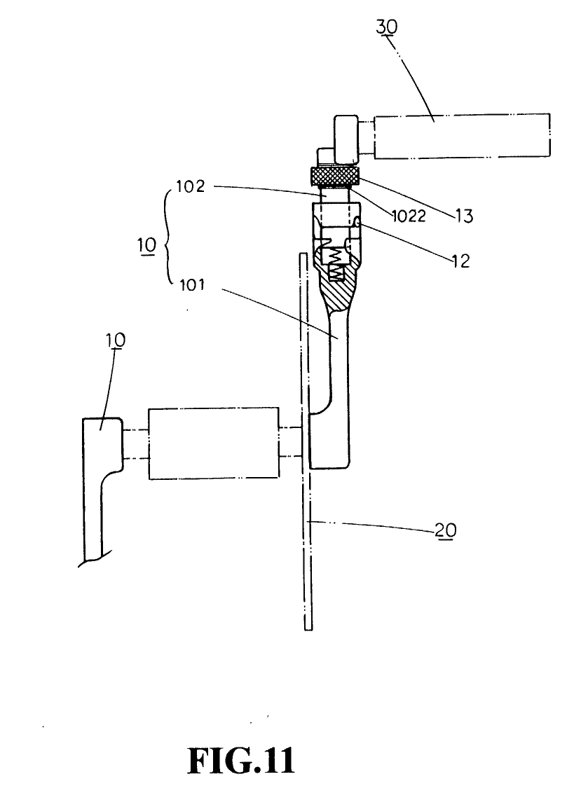

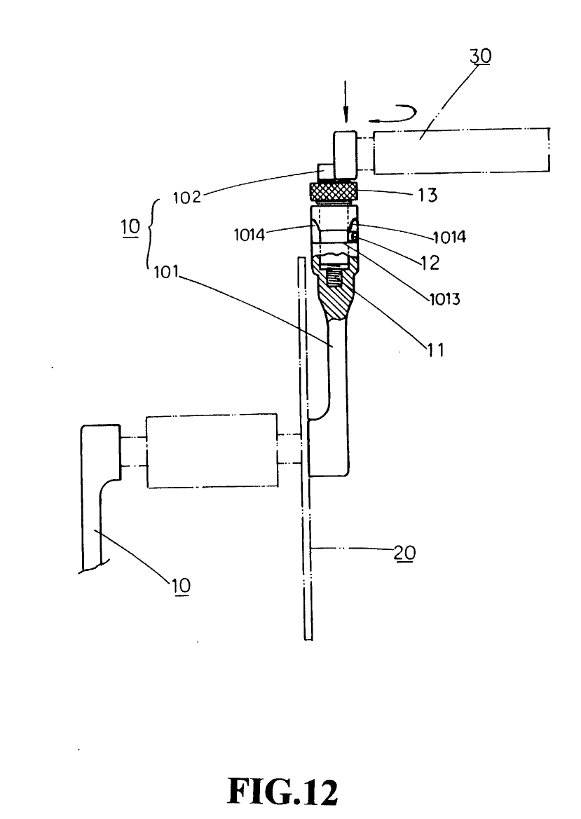

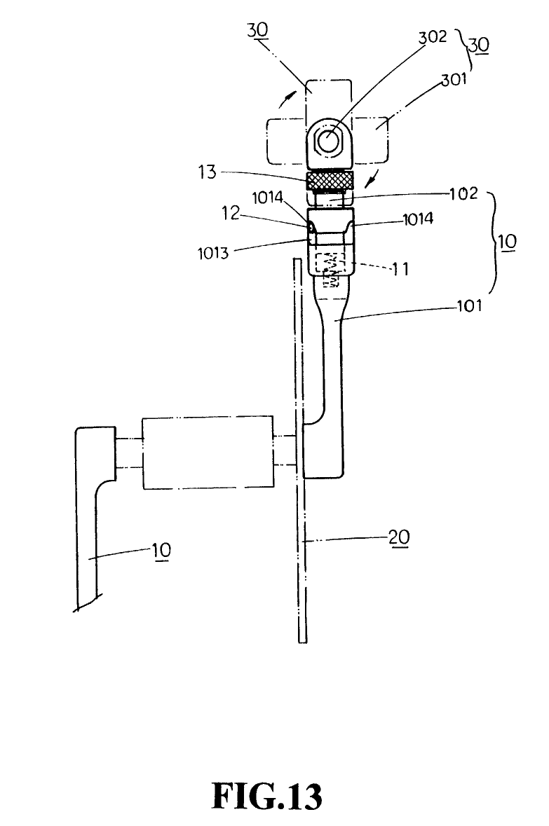

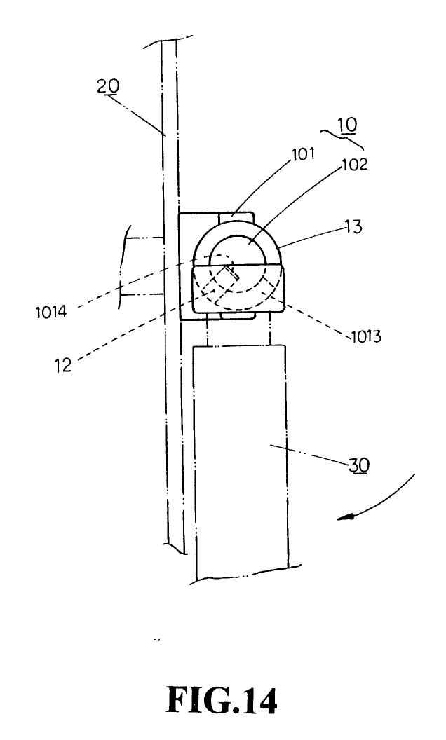

Referring to FIG. 11, FIG. 12, FIG. 13, and FIG. 14, when the host bicycle is not being utilized or prepared for packaging, the adjustment nut 13 is transposed outward so that it is no longer checks the end section of the fixed member 101 (as shown in FIG. 11), following which the said swivel member 102 is pulled inward (as shown in FIG. 12) to disengage the locating screw 12 from the detent notch 1014 and then, as the pivoting operation continues, the locating screw 12 is shifted along the transverse guide slot 1013 to the detent notch 1014 position at the opposite end (as shown in FIG. 14) and given the included angle θ of approximately 90 degrees between the two ends of the said transverse guide slot 1013, the pedal 30 that was originally in a perpendicular state relative to the chainring 20 and the crankarm 10 is swung along with the swivel member 102 approximately 90 degrees (as shown in FIG. 13 and FIG. 14) such that it is in an overlaid posture relative to the upper and lower ends of the crankarm 10 and since it is not prominent at the outer side of the crankarm 10, this not only improves the space occupancy and increased physical dimension shortcomings of the conventional non-foldable pedal, but also considerably and effectively improves the excessive space occupancy and physical dimension-related drawbacks of the said conventional foldable pedal. Since the swivel member 102 is preloaded by the seated elastic component 11, after it is pivoted approximately 90 degrees until the locating screw 12 is shifted to the end area of the transverse guide slot 1013, the action of the elastic component 11 ensures the said locating screw 12 is positively engaged in the detent notch 1014 to thereby achieve secure positioning.

In the said arrangement, since the pedal 30 foot contact section 301 spins freely on an axle 302, when the swivel member 102 is pivoted such that the pedal 30 does not provide for treadling, the said foot contact section 301 capable of being directly swung into an overlaid configuration relative to the upper and lower ends of the crankarm 10 (as shown in FIG. 13), thereby achieving the objective of reduced packaging dimensions.

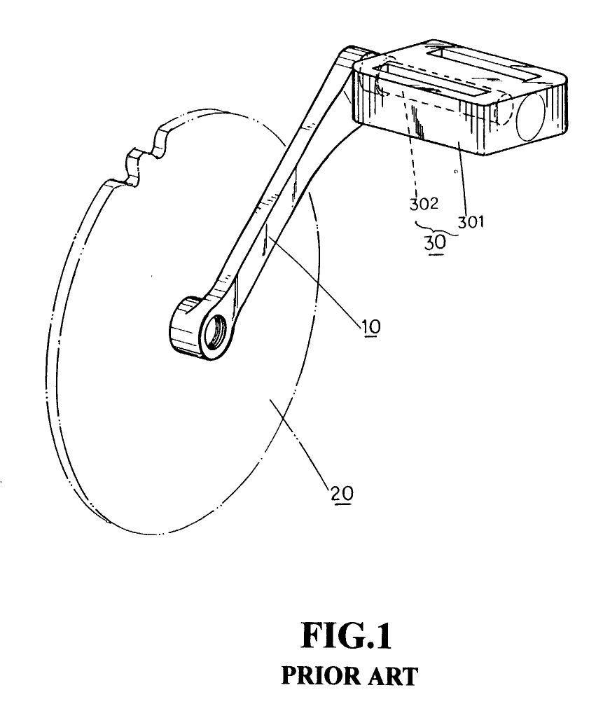

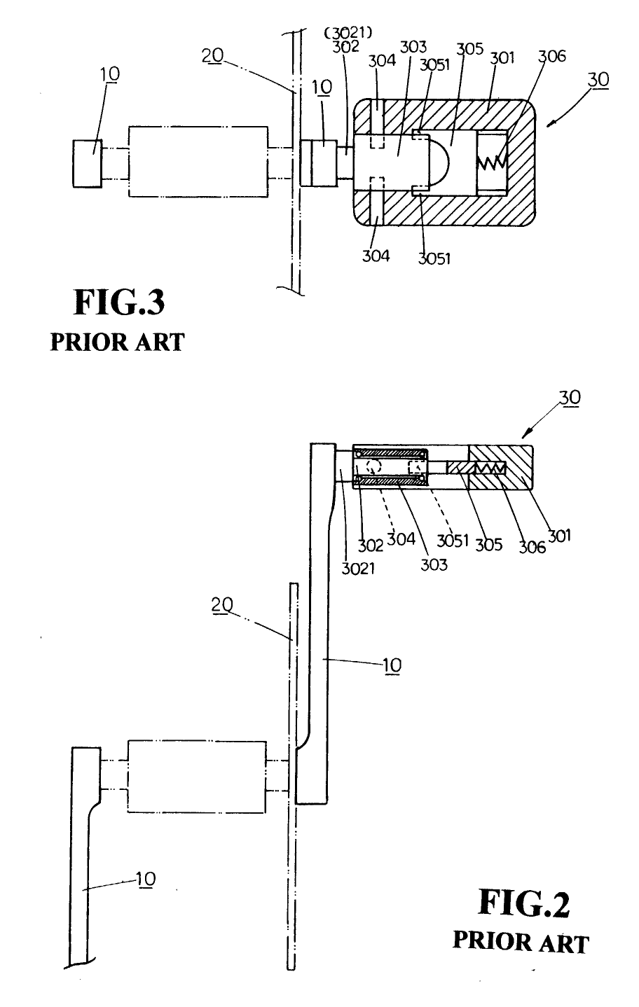

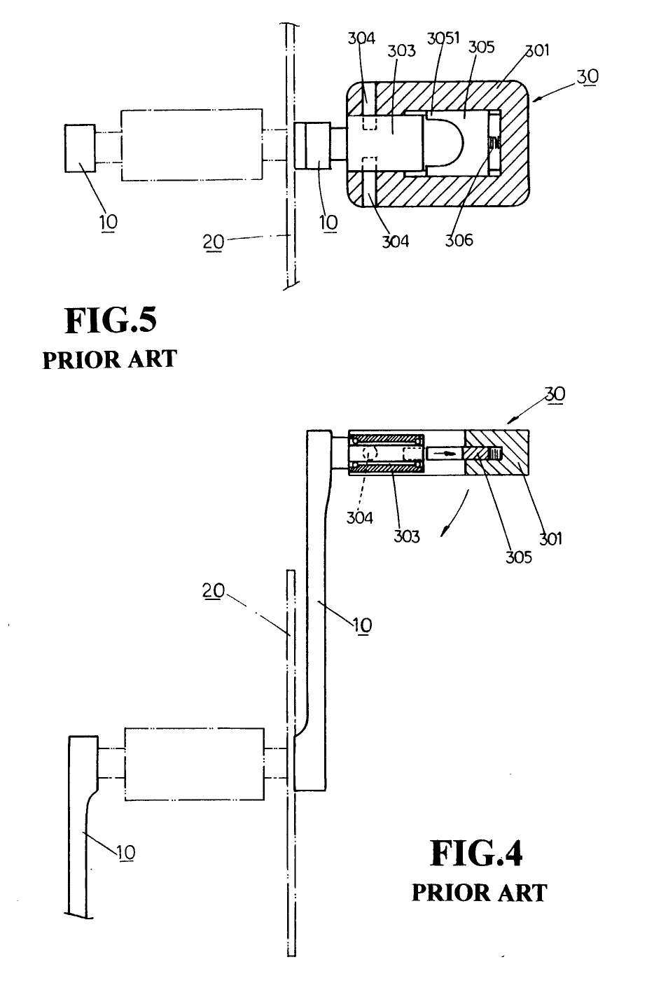

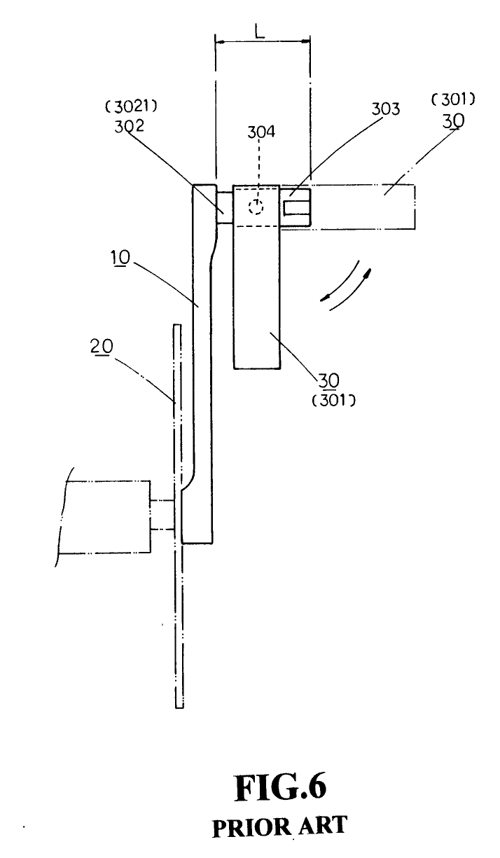

Given the said arrangement, when the swivel member 102 of the invention herein is pivoted such that the pedal 30 treadling is disabled, the said pedal 30 is unlike the conventional foldable pedal which is protuberant at the outer side of the crankarm, but is in an overlaid configuration that is aligned with the upper and lower ends of the crankarm 10; at the same time, the pedal 30 of the invention herein can be utilized as a conventional non-foldable pedal (as shown in FIG. 1) that is not only substantially more economical, but also directly improves the inadequate strength shortcoming of the conventional non-foldable pedal.

Furthermore, the pedal 30 axle 302 perpendicular to the crankarm 10 is subjected to the greatest force when the pedal 30 is treadled and, furthermore, the swivel member 102 and the fixed member 101 of the invention herein are conjoined along a common linear axis rather than perpendicularly arranged such that under conventional non-foldable conditions the said pedal 30 of the invention herein affords strength that ensures safe utilization.

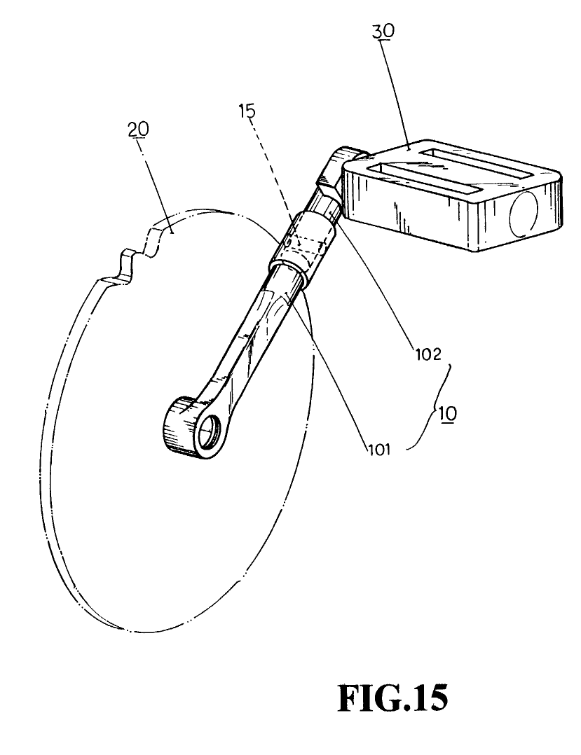

Referring to FIG. 15, another embodiment of the invention herein, after the said swivel member 102 is sleeved onto the fixed member 101, the equivalent conjoinment and variable positioning arrangement consists of a pin or a screw 15 that is inserted or fastened, wherein the necessary considerations are procedural convenience and the strength required to achieve conjoinment.

However, the said description of the drawings are only the most preferred embodiments of the invention herein and shall not be construed as a limitation of the embodiments of the present invention and, furthermore, all embellishments and similar modifications (such as the threaded conjoinment of the swivel member 102 and the fixed member 101 or the method of pivotably conjoining the fixed member 101 and the swivel member 102 because it is only necessary to install the pedal 30 on the swivel body 102 such that it pivots and, according to particular requirements, configure them in a perpendicular state relative to the crankarm 10 and the chainring 20 or configure them in an overlaid posture relative to the upper and lower ends of the crankarm 10) based on the spirit and scope of the invention herein shall remain included within the patent application claims of the invention herein.

1. An improved bicycle crankarm, the innovative features of which include:
the said crankarm consists of a fixed member and a swivel member, wherein the inner end of the said fixed member is attached to a chainring and its outer end is conjoined to the freely pivoting said swivel member, with the said swivel member providing for the installation of a pedal at its outer end; after the inner end of the said swivel member 1 is conjoined to the outer end of the said fixed member in a freely pivotable state, it can be pivoted such that the said pedal is in a perpendicular state relative to the said crankarm or the said chainring and, furthermore, swung approximately 90 degrees such that the said pedal is in an overlaid posture relative to the upper and lower ends of the said crankarm.

2. As mentioned in claim 1 of the improved bicycle crankarm of the invention herein, the said fixed member consists of a barrel having a recess disposed in its outer end; a transverse guide slot having an included angle of approximately 90 degrees between its two ends is continuously formed in the wall of the barrel, a detent notch extends outward from each of the two ends of the said guide slot, and an elastic component is seated in the said recess.

3. As mentioned in claim 1 and claim 2 of the improved bicycle crankarm of the invention herein, after the inner end of the said swivel member is placed into the said recess of the said fixed member with the said elastic component seated inside, a locating screw is installed in a first threaded hole tapped in its wall at one of the said detent notches positioned at the two ends of the said transverse guide slot of the said fixed member, and an adjustment nut is installed on male threads died near its outer end.

4. As mentioned in claim 1 and claim 2 of the improved bicycle crankarm of the invention herein, the position (orientation) of the said fixed member horizontal guide slot is such that when the said locating screw fastened in the said swivel member engages a said detent notch at one of its ends, the said pedal is in a perpendicular state relative to the said crankarm and the said chainring; when the said locating screw is shifted to the said detent notch at it opposite end, the said pedal is in an overlaid posture relative to the upper and lower ends of the said crankarm.

5. As mentioned in claim 1 of the improved bicycle crankarm of the invention herein, the said fixed member and the said swivel member can be pivotably conjoined by means of respectively disposed threads.
